(19) United States
(12) Patent Application Publication
(10) Pub. No.: US 2010/0038422 A1
(43) Pub. Date: Feb. 18, 2010

(54) RFID BASED DISTRIBUTED COMPUTING SYSTEM

(76) Inventor: MARIO W. CARDULLO, Alexandria, VA (US)

Correspondence Address: MCGUIREWOODS, LLP, 1750 TYSONS BLVD, SUITE 1800, MCLEAN, VA, 22102, US

(21) Appl. No.: 12/542,367

(22) Filed: Aug. 17, 2009

Related U.S. Application Data
(60) Provisional application No. 61/089,715, filed on Aug. 18, 2008.

(51) Int. Cl. G06F 19/00; G06F 17/00

(52) U.S. Cl. 235/385; 235/375

(57) ABSTRACT

A radio-frequency identification (RFID) based computing system includes a plurality of processing stations configured to execute a computer program in a distributed manner. Each processing station includes a radio-frequency identification (RFID) code unique to each processing station, a radio-frequency (RF) communication unit configured to exchange information with other processing stations via a radio frequency, the information including one or more RFID codes of the processing stations, one or more segments of the computer program or one or more portions of data for execution, and a processing unit configured to process the data distributed thereto. The computing system manages segmentation and distribution of the information and collection of execution results of the processing of the data by the processing stations.

### CROSS REFERENCE TO PRIOR APPLICATION

This application claims priority and the benefit thereof from U.S. Provisional Patent Application No. 61/089,715 filed on Aug. 18, 2008, which is hereby incorporated by reference for all purposes as if fully set forth herein.

### BACKGROUND OF THE DISCLOSURE

1. Field of the Disclosure

This disclosure is directed to a computing system, and, particularly, a radio-frequency identification (RFID) based distributed computing system.

2. Related Art

Radio-frequency identification (RFID) is an automatic identification method, which relies on storing and remotely retrieving data using RFID tags or transponders. An RFID tag is a device that can be applied to or incorporated into a product, animal, or person for the purpose of identification using radio waves. Some tags can be read from several meters away and beyond the line of sight of the reader. Most RFID tags contain at least two parts. One is an integrated circuit for storing and processing information, modulating and demodulating a (RF) signal, and other specialized functions. The second is an antenna for receiving and transmitting the signal.

The RFID is becoming increasingly prevalent as the price of the technology decreases. For example, RFID tags are currently used in transportation payment, product tracking, animal identification, inventory systems, passports and the like. However, the use of RFID tags have been limited to simple identification and tracking tasks, due to their passive and limited functionalities.

### SUMMARY OF THE DISCLOSURE

In one aspect of the disclosure, a radio-frequency identification (RFID) based computing system includes a plurality of processing stations configured to execute a computer program in a distributed manner. Each processing station includes a radio-frequency identification (RFID) code unique to each processing station, a radio-frequency (RF) communication unit configured to exchange information with other processing stations via a radio frequency, the information including one or more RFID codes of the processing stations, one or more segments of the computer program or one or more portions of data for execution, and a processing unit configured to process the data distributed thereto. The computing system manages segmentation and distribution of the information and collection of execution results of the processing of the data by the processing stations.

Each processing station may further include a device controlled by the processing unit to perform a function. The function may include at least one of an inventory tracking function, a sensing function, a detecting function and a position determination function.

The plurality of processing stations may include a master processing station configured to manage the segmentation and distribution of the computer program and the collection of the execution results, and a plurality of slave processing stations, each configured to execute the computer program segment distributed thereto. Each processing station may be configured to function as the master processing station.

The master processing station may be further configured to manage collecting the RFID codes of the plurality of slave processing stations, associating each computer program segment to an RFID code of a slave processing station, and distributing the computer program segments to the slave processing stations having the RFID codes associated thereto, respectively. The master station may be further configured to determine a number of the slave processing stations required for executing the computer program and communicating with the number of the slave processing stations to execute the computer program.

The computer system may be divided into one or more processing groups, each processing group including at least one processing station. At least one of the processing groups may be divided into one or more processing sub-groups, and each sub-group may include at least one processing station.

In another aspect of the disclosure, a method of executing a computer program using a radio-frequency identification (RFID) based computing system, the computer system including a plurality of processing stations with unique RFID codes, respectively, and configured to execute the computer program in a distributed manner, includes programming the computer system with the computer program, attaching the plurality of processing stations to a plurality of objects, respectively, executing the computer program to acquire target data from the plurality of objects, associating the target data of each target unit to the RFID of the processing station corresponding thereto, collecting the RFID and the target data associated thereto from each processing station, and generating status information of the objects based on the collected RFID and the target data associate thereto from each processing station. The RFID and the target data associated thereto may be collected in a real time.

The status information may be inventory information, the objects may include a plurality of items, and the target data may include item information of each item. The item information may include at least one of a model number, a serial number, a price, a size, a color and a location of each item.

The status information may include traffic information, the objects may include a plurality of vehicles, and the target data may include driving information of each vehicle. The target data may include at least one of a location, a speed and a driving direction of each vehicle.

The status information may include combat status information, the plurality of objects may include a plurality of soldiers, and the target data may include battle status information of each soldier. The battle status information may include at least one of a location, a vital sign and a movement direction of each soldier.

The status information may include surveillance information, the objects may include a plurality of surveillance areas, and the target data may include surveillance data in each surveillance area. The surveillance data may include at least one of a movement, a movement time and a movement frequency in each surveillance area. The surveillance information comprises at least one of a movement, a movement direction and a number of movements in the surveillance areas.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an overview of a radio-frequency identification (RFID) based distributed computing system (DCS), constructed according to the principles of the disclosure;

FIG. 2 shows an exemplary configuration of a processing station shown in FIG. 1, constructed according to the principles of the disclosure;

FIG. 3 shows a flow chart of a method for tracking an inventory using a DCS, according to the principles of the disclosure;

FIG. 4 shows a flow chart of a traffic tracking method using a DCS, according to the principles of the disclosure;

FIG. 5 shows a flow chart of a combat status tracking method using a DCS, according to the principles of the disclosure; and

FIG. 6 shows a flow chart of a surveillance method using a DCS, according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

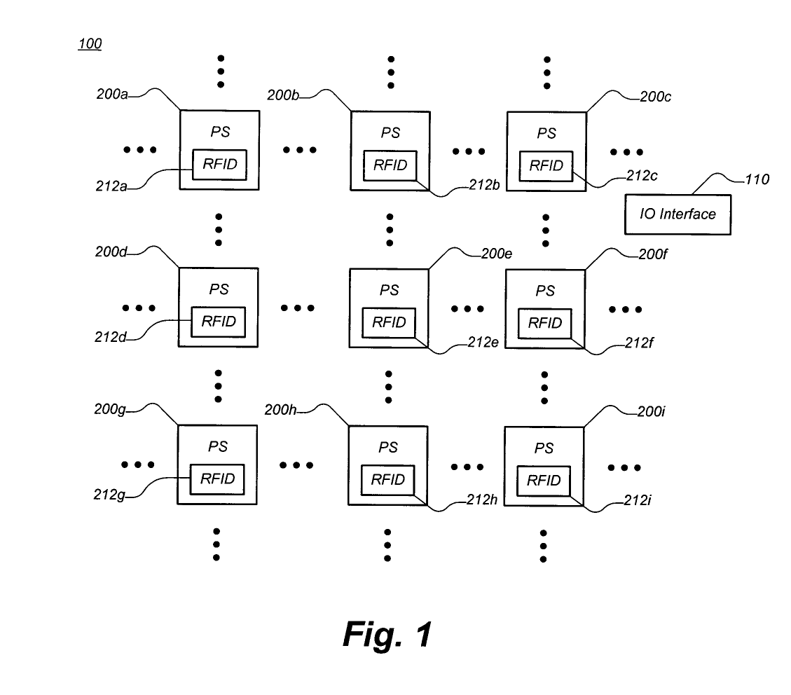

FIG. 1 shows a conceptual overview of a radio-frequency identification (RFID) based distributed computing system (DCS) 100, constructed according to the principles of the disclosure. The DCS 100 may be configured to execute a computer program in a distributed manner. The DCS 100 may include a number of processing stations (PS) 200, for example, a PS 200a, a PS 200b, a PS 200c, a PS 200d, a PS 200e, a PS 200f, a PS 200g, a PS 200h, a PS 200i, and/or the like. Each of the processing stations 200 may include a radio-frequency identification (RFID) code 212, such as, an RFID code 212a, an RFID code 212b, an RFID code 212c, an RFID code 212d, an RFID code 212e, an RFID code 212f, an RFID code 212g, an RFID code 212h, an RFID code 212i, or the like. Each RFID code 212 may be unique to the PS 200 corresponding thereto.

The DSC 100 may have a flexible construction. For example, the number of PS 200 in the DSC 100 involved in executing a computer program and/or processing data may vary depending on complexity and/or length of the computer program. To execute a more complex and/or longer computer program and/or data, the DSC 100 may involve a larger number of PS 200. For a simpler and/or shorter computer programs and/or data, a smaller number of PS 200 may be involved. The DCS 100 may have a fixed number of PS 200, but may be allowed to borrow or lend processing stations from or to another DCS. Moreover, the number of PS 200 may affect the processing time of the computer program and/or data.

The DSC 100 may optimally divide a computer program and/or data into a plurality of computer program and/or data segments and distribute each computer program and/or data segment to each PS 200. The distribution of the computer program and/or data segments may be based on the RFID codes 212 of the PS 200. When communicating each other, each PS 200 may transmit its RFID code 212 to identify itself, and receive the RFID codes 212 from other PS 200 for identification thereof. The PS 200 may communicate with each other wirelessly via radio frequencies (RF) to exchange a computer program, data, RFID codes and/or the like.

To manage overall operations of the DCS 100, one or more PS 200 may perform as a master processing station (MPS) and other PS 200 may functions as slave processing stations (SPS). Any PS 200 may be selected as an MPS. Each PS 200 may be configured to function as both an MPS and SPS. During the operation, one PS's role as an MPS or SPS may be changed to another role if necessary. For example, the PS 200e may operate as the MPS of the DCS 100 initially but later on the PS 200e may become an SPS and the PS 200a may become the new MPS. Also, when more processing power is needed, an MPS may use one or more SPS as secondary MPS. Alternatively, one or more PS 200 may be specifically configured to function as an MPS. Furthermore, the DCS 100 may be divided into a plurality of processing groups. Each processing group may have at least one PS 200. Also, each processing station may be further divided into a plurality of processing sub-groups. Each of the processing groups and the processing sub-group may have its own MPS.

Assuming that the PS 200e is the MPS of the DCS 100 and the PS 200a, 200b, 200c, 200d, 200f, 200g, 200h, 200i are the SPS, the MPS 200e may communicate with the SPS 200a, 200b, 200c, 200d, 200f, 200g, 200h, 200i to collect their RFID codes 212a, 212b, 212c, 212d, 212f, 212g, 212h, 212i and the like. Also, the MPS 200e may send its RFID 212e to the SPS 200a, 200b, 200c, 200d, 200f, 200g, 200h, 200i to notify its role as the MPS and so on. Based on the collected RFID codes 212a, 212b, 212c, 212d, 212f, 212g, 212h, 212i, the MPS 200e may determine the configuration, construction and processing power of the DCS 100. The MPS 200e may also analyze a computer program and/or data provided to the DCS 100 and determine how to optimally divide the computer program and/or data into a plurality of computer program and/or data segments for the SPS 200a, 200b, 200c, 200d, 200f, 200g, 200h, 200i.

The MPS 200e may distribute each computer program and/or data segment to the SPS 200a, 200b, 200c, 200d, 200f, 200g, 200h, 200i based on the RFID codes 212a, 212b, 212c, 212d, 212f, 212g, 212h, 212i thereof. More specifically, before the MPS 200e sends a computer program and/or data segment to the SPS 200a, the MPS 200e may associate the computer program and/or data segment to the RFID code 212a of the SPS 200a. Also, once the SPS 200a completes execution of the computer program segment and/or processing of the data distributed thereto, the SPS 200a may associate its RFID code 212a to the execution result and send both the execution result and RFID code associated thereto to the MPS 200e. The MPS 2003 may collect the RFID code 212 and execution result from each SPS, pieces the collected execution results together based on the RFID codes 212, and complete execution of the computer program and/or data.

The MPS 200e may function as data input and/or output terminals of the DCS 100. Alternatively, the DCS 100 may include a designated 10 interface 110 to exchange the computer program and/or data with a user and/or an external device. The 10 interface 110 may receive a computer program and/or data and send the instructions to the MPS 200e, or, alternatively, distribute the computer program and/or data segments to the PS 200. The I/O interface 110 may be further configured to perform the functions of the master processing station.

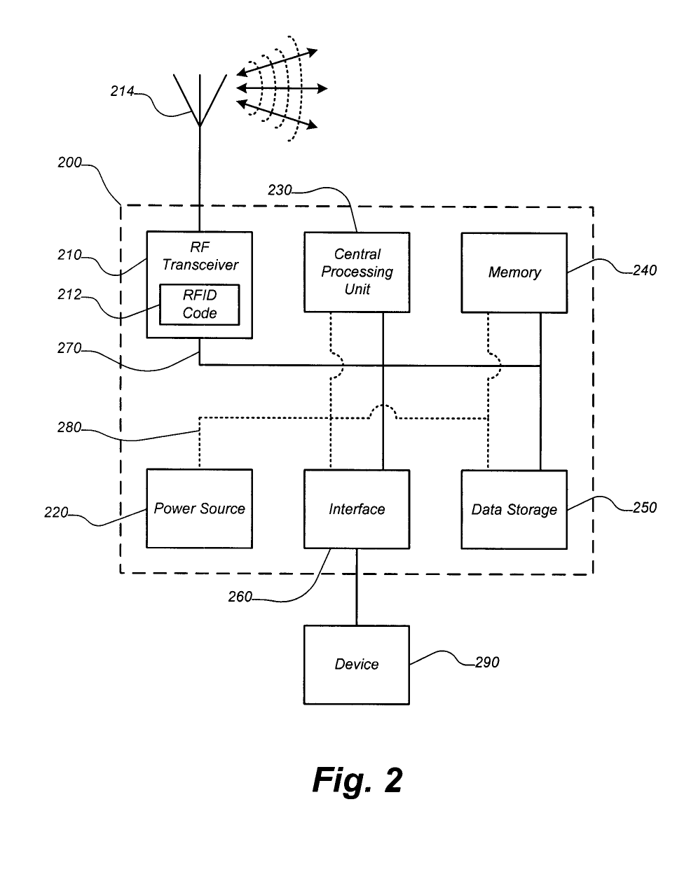

FIG. 2 shows a configuration of the PS 200 shown in FIG. 1, constructed according to the principles of the disclosure. The PS 200 may include a radio-frequency (RF) transceiver 210, a power source 220, a central processing unit (CPU) 230, a memory 240, a data storage 250, an interface unit 260, a data bus 270, a power line 280 and/or the like. The RF transceiver 210 may include the RFID code 212 (also referred to as an RFID tag) and an antenna 214. However, the RFID code 212 may be located outside the RF transceiver 210.

The RF transceiver 210 may transmit the RFID code to other processing stations 200 and receive the RFID codes of other processing stations 200. Also, the RF transceiver 210 may exchange one or more computer program, data segments and/or the like with other processing stations 200. Once the computer program and/or data segment is executed and/or processed by the central processing unit 230, the RF transceiver 210 may transmit the execution result to other PS 200. The memory 240 and the data storage 250 may be used to assist operations of the CPU 230, as well known in the art. The power source 220 may provide power to the radio-frequency (RF) transceiver 210, the central processing unit (CPU) 230, the memory 240, the data storage 250, the interface unit 260 and/or the like.

The interface unit 260 may provide an interface between the processing unit 200 and a device 290 which may be controlled by the processing unit 200. The device 290 may perform at least one function, such as, for example, an inventory tracking function, a sensing function, a detecting function, a position determination function and/or the like, which are described below in detail. The sensing function may include one or more functions for sensing a time, a temperature, a velocity, a speed, an acceleration, a pressure, a motion, a sound, and/or the like, using known sensing devices such as load cells, thermistors, thermocouples, and the like. In particular, the sensing function may include one or more functions for sensing a blood pressure, a heart rate, a body temperature, a respiratory activity and/or the like. The position determination function may include acquiring a geographical coordinate using, for example, the Global Positioning System (GPS). Other types of position determination function are also contemplated.

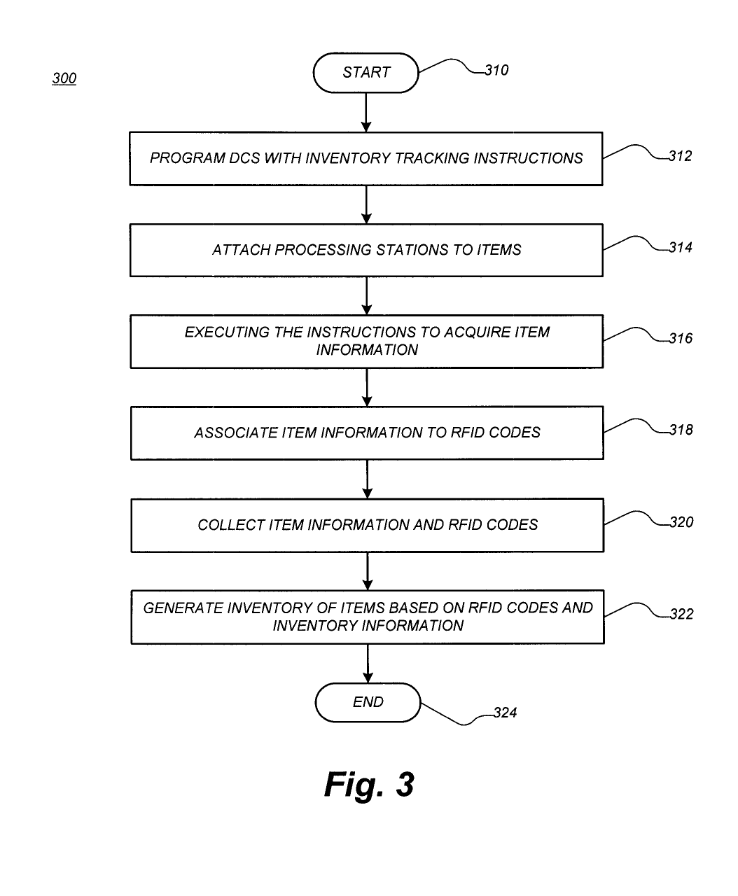

The RFID based DCS 100 may have a variety of industrial and military applications. For example, FIG. 3 shows a flow chart 300 of a method for tracking an inventory using a DCS, constructed according to the principles of the disclosure. Upon starting the process at step 300, the DSC may be programmed with a computer program and/or data including instructions for tracking an inventory of items at step 312. The instructions may include instructions for acquiring item information, such as, e.g., a model number, a serial number, a price, a size, a color, a location and/or the like of each item. Furthermore, each PS may include a location determination device, which may detect a change in a location of the item. Each PS may be attached to an item at step 314.

Then, the DCS may execute the instructions to acquire the item information of each item at step 316. The item information may be provided from an external data storage and stored in the memory of the PS. The instructions also include updating changes in the item information. For example, when an item is moved from one location to another, the PS attached to the item may automatically recognize the new location and update the item location in the item information. The acquired item information of each item may be associated with the RFID code of the PS attached to the item at step 318. The RFID codes and associated item information are collected at step 320. Then, inventory information of the items may be generated based on the collected RFID codes and item information associated thereto, respectively, at step 322, and the process may end at step 324.

Thus, it may no longer be necessary to scan the items whenever they are moved from one location to another. In a retail environment, the inventory information (e.g., location, price, quantity and the like of the items) may be quickly provided to shoppers (to find, purchase, and so on) and to store employees (to restock, reorder, and so on).

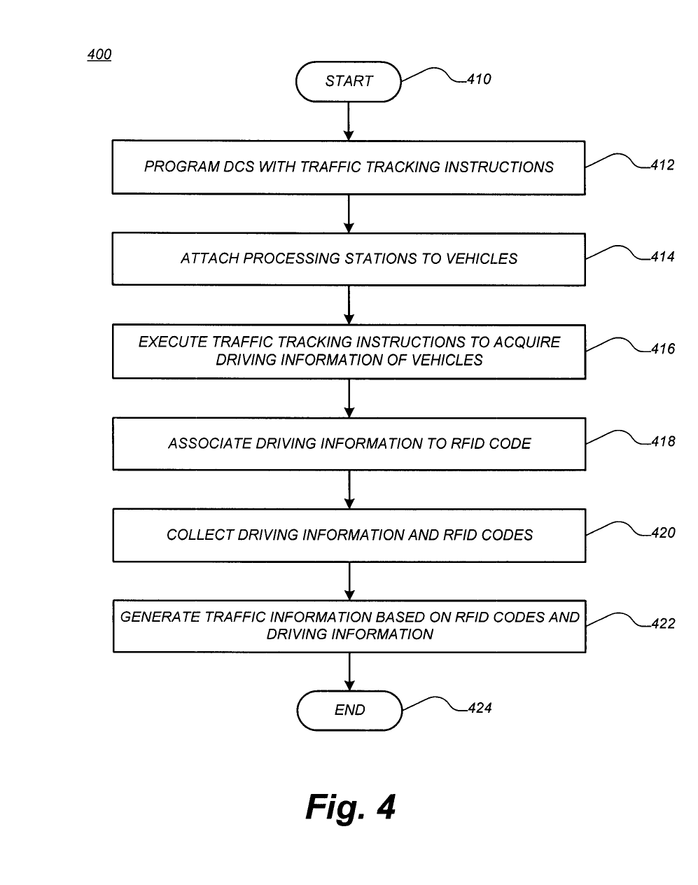

FIG. 4 shows a flow chart 400 for a traffic tracking method using a DCS, constructed according to the principles of the disclosure. Upon starting the process at step 410, the DSC may be programmed with a computer program and/or data including instructions for tracking vehicle traffic at step 412. For this purpose, each PS may include a device for acquiring driving information, such as, e.g., a location, a speed, a driving direction and/or the like) of a vehicle. Each PS may be attached to a vehicle at step 414. Each PS may execute the instructions to acquire the driving information of the corresponding vehicle at step 416. The acquired driving information of the vehicle may be associated with the RFID code of the PS attached to the vehicle at step 418. The RFID codes and driving information of the vehicles may be collected at step 420. Then, traffic information of the vehicles may be generated based on the collected RFID codes and driving information at step 422, and the process may end at step 424. Further, the PS incorporated in vehicles may communicate with each other and/or a traffic control center to provide and obtain the traffic information (e.g., speed, congestion, accident and/or the like), to provide vehicle guidance, anti-collision/collision avoidance, and the like.

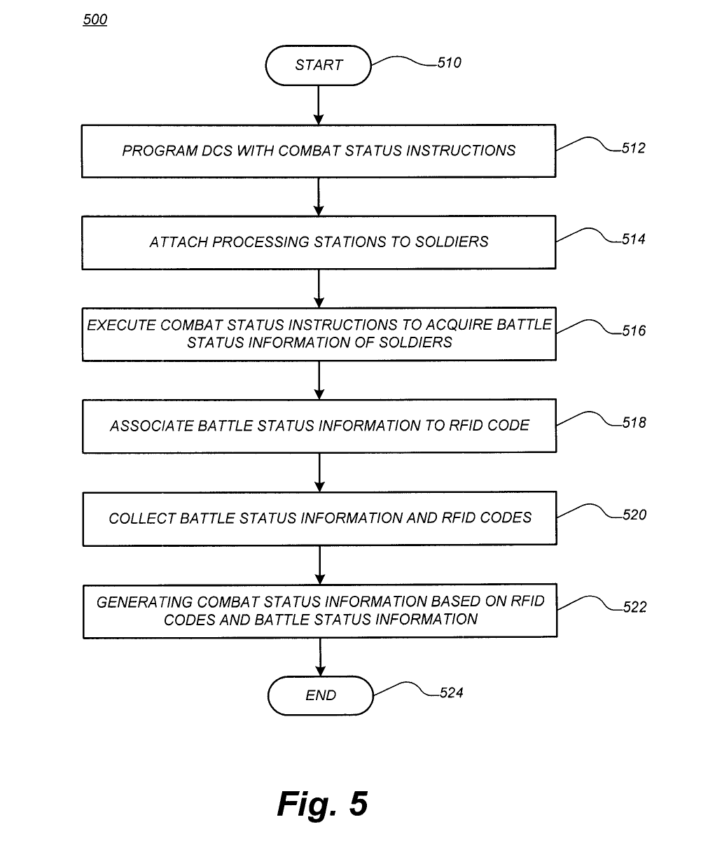

FIG. 5 shows a flow chart 500 of a combat status tracking method using a DCS, constructed according to the principles of the disclosure. Upon starting the process at step 510, a DCS may be programmed with a computer program and/or data including instructions for tracking a combat status (e.g., a number of troops, a movement direction and/or speed of troops, a number of casualties, severity of injury, a mission completion level and/or the like) at step 512. For this purpose, each PS may include a device, a sensor and/or the like for detecting and/or monitoring a soldier's battle status information, such as, e.g., a location, a vital sign, a movement direction and/or the like. Each PS may be attached to a soldier at step 514. Each PS may execute the instructions to acquire the soldier's battle status information at step 516. The acquired battle status information may be associated with the RFID code of the PS attached to the soldier at step 518. The RFID codes and battle status information of the soldiers may be collected at step 520. The combat status information of the soldiers may be generated based on the collected RFID codes and battle status information at step 522, and the process may end at step 524. The PS may be combined with a global positioning system (GPS) to report the location, movement, direction, health status of the soldier to a command center.

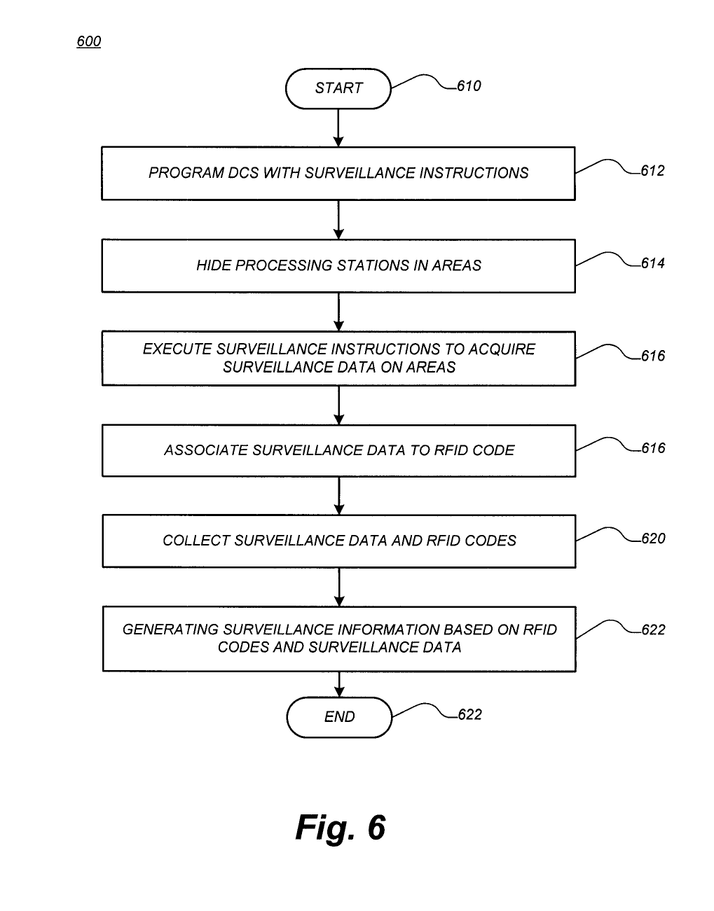

FIG. 6 shows a flow chart of a surveillance method using a DCS, constructed according to the principles of the disclosure. Upon starting the process at step 610, a DCS may be programmed with a computer program including instructions for surveying areas at step 612. For this purpose, each PS may include a motion detector or the like, to detect movement in a corresponding area. Each PS may be attached (or hidden) in each area at step 614. Each PS may execute the instructions to acquire surveillance data (e.g., a movement, a movement time, a movement frequency and/or the like) in the corresponding area at step 616. The acquired surveillance data may be associated with the RFID code of the PS hidden in the area at step 618. The RFID codes and surveillance data of the areas may be collected at step 620. The surveillance information of the areas may be generated based on the collected RFID codes and surveillance data at step 622, and the process may end at step 624. In an embodiment, the processing stations may be spread out in a battlefield to detect enemy information (e.g., movement, number, direction, occupied area and/or the like) and return the information to a command center.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A radio-frequency identification (RFID) based computing system comprising a plurality of processing stations configured to execute a computer program in a distributed manner, each processing station comprising:
a radio-frequency identification (RFID) code unique to each processing station;
a radio-frequency (RF) communication unit configured to exchange information with other processing stations via a radio frequency, the information comprising one or more RFID codes of the processing stations, one or more segments of the computer program or one or more portions of data for execution; and
a processing unit configured to process the data distributed thereto,
wherein the computing system manages segmentation and distribution of the information and collection of execution results of the processing of the data by the processing stations.

2. The computing system of claim 1, wherein each processing station further comprises a device controlled by the processing unit to perform a function.

3. The computing system of claim 2, wherein the function comprises at least one of an inventory tracking function, a sensing function, a detecting function and a position determination function.

4. The computing system of claim 1, wherein the plurality of processing stations comprise:
a master processing station configured to manage the segmentation and distribution of the computer program and the collection of the execution results; and
a plurality of slave processing stations, each configured to execute the computer program segment distributed thereto.

5. The computing system of claim 4, wherein each processing station is configured to function as the master processing station.

6. The computing system of claim 4, wherein the master processing station is further configured to manage collecting the RFID codes of the plurality of slave processing stations, associating each computer program segment to an RFID code of a slave processing station, and distributing the computer program segments to the slave processing stations having the RFID codes associated thereto, respectively.

7. The computing system of claim 6, wherein the master station is further configured to determine a number of the slave processing stations required for executing the computer program and communicating with the number of the slave processing stations to execute the computer program.

8. The computer system of claim 1, being divided into one or more processing groups, each processing group comprising at least one processing station.

9. The computing system of claim 8, wherein at least one of the processing groups is divided into one or more processing sub-groups, each sub-group comprising at least one processing station.

10. A method of executing a computer program using a radio-frequency identification (RFID) based computing system, the computer system comprising a plurality of processing stations with unique RFID codes, respectively, and configured to execute the computer program in a distributed manner, the method comprising:
programming the computer system with the computer program;
attaching the plurality of processing stations to a plurality of objects, respectively;
executing the computer program to acquire target data from the plurality of objects;
associating the target data of each target unit to the RFID of the processing station corresponding thereto;
collecting the RFID and the target data associated thereto from each processing station; and
generating status information of the objects based on the collected RFID and the target data associate thereto from each processing station.

11. The method of claim 10, wherein the RFID and the target data associated thereto is collected in a real time.

12. The method of claim 10, wherein the status information is inventory information, the plurality of objects comprise a plurality of items, and the target data comprises item information of each item.

13. The method of claim 12, wherein the item information comprises at least one of a model number, a serial number, a price, a size, a color and a location of each item.

14. The method of claim 10, wherein the status information is traffic information, the plurality of objects comprise a plurality of vehicles, and the target data comprises driving information of each vehicle.

15. The method of claim 14, wherein the target data comprises at least one of a location, a speed and a driving direction of each vehicle.

16. The method of claim 12, wherein the status information is combat status information, the plurality of objects comprise a plurality of soldiers, and the target data comprises battle status information of each soldier.

17. The method of claim 16, wherein the battle status information comprises at least one of a location, a vital sign and a movement direction of each soldier.

18. The method of claim 12, wherein the status information comprises surveillance information, the plurality of objects comprise a plurality of surveillance areas, and the target data comprises surveillance data in each surveillance area.

19. The method of claim 18, wherein the surveillance data comprises at least one of a movement, a movement time and a movement frequency in each surveillance area.

20. The method of claim 18, wherein the surveillance information comprises at least one of a movement, a movement direction and a number of movements in the plurality of surveillance areas.
